(19) United States
(12) Patent Application Publication
(10) Pub. No.: US 2005/0218139 A1
(43) Pub. Date: Oct. 6, 2005

(54) Intelligent user interface for new cooking technologies

(75) Inventors: Luis Cavada, Miami, FL (US); Alvaro Vallejo Noriega, Queretaro (MX); Victoria Vilbrandt, Hollywood, FL (US)

Correspondence Address: BAKER BOTTS, LLP, 910 LOUISIANA, HOUSTON, TX, 77002-4995, US

(73) Assignee: HP Intellectual Corporation

(21) Appl. No.: 10/815,098

(22) Filed: Mar. 31, 2004

(51) Int. Cl. H05B 1/02; H05B 6/66

(52) U.S. Cl. 219/720; 219/702; 219/506

(57) ABSTRACT

Cooking with new technologies by providing an intelligent user interface for the selection of predefined new technology cooking profiles for a number of different foods. When a food has not been predefined for the new cooking technology, procedures used for conventional cooking technologies may converted to the desired new cooking technologies so as to obtain substantially the same cooking results for the desired food. The intelligent user interface is used in selecting from a menus of a plurality of different foods for programming a new technology cooking profile for the selected food to be cooked. Profile parameters for the new technology cooking may be empirically determined and/or extrapolated from profile parameters determined from cooking of similar foods. Predefined “hot buttons” may be used for quick selection of a cooking profile for a desired food (e.g., common foods such as popcorn, pizza rolls, chicken wings, oven fries, and other prepared and frozen foods), and/or a menu screen may be scrolled through to select a cooking profile for the desired food.

### RELATED PATENT APPLICATION

This patent application is related to commonly owned patent application U.S. Ser. No. 10/776,028, filed Feb. 10, 2004, entitled “Multi-Purpose Oven Using Infrared Heating For Reduced Cooking Time” by Luis Cavada and Alvaro Vallejo, and is hereby incorporated by reference herein for all purposes.

### BACKGROUND OF THE INVENTION TECHNOLOGY

1. Field of the Invention

The present invention relates to selecting cooking parameters in the preparation of foods, and more specifically, selecting cooking parameters using an intelligent user interface to select the cooking parameters of new cooking technologies in the preparation of foods.

2. Background of the Related Technology

Over the years there have been many attempts to introduce new cooking technologies that would allow faster cooking of foods. These new cooking technology products, e.g., convection, microwave, quartz light and infrared ovens, have been devised in order to try and speed up the cooking process. However the new cooking technologies caused consumers to guess how to properly cook foods, e.g., time, power used, etc. Guidelines were presented as to how to best cook using a new technology, but required much trial and error before satisfactory cooking results were obtained. Quite often the user was frustrated and took a long time to arrive at reasonable results.

With subsequent technology enhancements in the new cooking technology products, e.g., microwave ovens, these products began to include some pre-programmed functions, e.g., buttons for cooking popcorn, baked potatoes, and frozen foods. Unfortunately, these pre-programmed functions still fell short in meeting the user's expectations. With differing amounts of food to be cooked, these pre-programmed functions proved inadequate for all situations. Yet other new technologies provided a complex interface where the user was required to reply to multiple questions in order to approximate a cooking cycle. The resulting cooking cycle would be adjusted for the amount of food to be cooked. This was particularly important since the new cooking technologies were not able to cook varying amounts of food in the same time frame.

Therefore, a problem exists, and a solution is needed for better and more consistent results when cooking foods with new cooking technologies.

### SUMMARY OF THE INVENTION

The invention remedies the shortcomings of using new cooking technologies by providing an intelligent user interface for the selection of predefined new technology cooking profiles for a number of different foods. When a food has not been predefined for the new cooking technology, procedures used for conventional cooking technologies may converted to the desired new cooking technologies so as to obtain substantially the same cooking results for the desired food.

According to an embodiment of the invention, selection from a menus of a plurality of different foods may be used for programming a new technology cooking profile for the selected food to be cooked. Profile parameters for the new technology cooking may be empirically determined and/or extrapolated from profile parameters determined from cooking of similar foods. Predefined “hot buttons” may be used for quick selection of a cooking profile for a desired food (e.g., common foods such as popcorn, pizza rolls, chicken wings, oven fries, and other prepared and frozen foods), and/or a menu screen may be scrolled through to select a cooking profile for the desired food.

According to another embodiment of the invention, a user may simply define a cooking profile using a familiar method, e.g., from a standard cookbook and/or prior experience, e.g., old family recipe, and then this familiar cooking profile may be converted to an equivalent cooking profile appropriate for the new cooking technology being used. The present invention may correlate standard instructions for cooking foods, e.g., in a conventional oven, to the necessary control and timing profiles for cooking the same food using a new technology, e.g., an infrared oven. When the user desires to cook a food whose cooking profile has not been correlated to the new technology, the user may optionally select a custom menu option, e.g., convert-menu. The convert-menu may query the user for information that may be used for converting a conventional cooking profile for a food to an equivalent operating profile for cooking the food with the new technology. The user may be asked to enter the type of food, e.g., meat, fish, poultry, vegetables, pastry, pies, etc., and the conventional cooking temperature and time for that food. The type of food, and the conventional cooking temperature and time may then be used for converting to an equivalent operating profile for cooking the food with the new technology. Weight and/or thickness of the food also may used in the profile conversion process. Thus, the conversion process may use the conventional cooking parameters and type of food, optionally including weight and/or thickness to create an appropriate new cooking technology profile for that food.

A technical advantage of the invention is more predictable cooking of foods by a new cooking technology. Another technical advantage is ease of use by people of different cooking abilities. Yet another advantage is quick selection of commonly cooked foods. Still another technical advantage is conversion of known cooking profiles of conventional ovens to the new technology cooking to produce substantially the same food cooking result. Other technical advantages should be apparent to one of ordinary skill in the art in view of what has been disclosed herein.

### BRIEF DESCRIPTION OF THE DRAWINGS

A more complete understanding of the present disclosure and advantages thereof may be acquired by referring to the following description taken in conjunction with the accompanying drawings wherein:

FIG. 1 is a schematic elevational front view of a new technology cooking appliance;

FIG. 2 is a schematic elevational side view of the appliance illustrated in FIG. 1;

FIG. 3 is a schematic elevational side of an intelligent user interface, according to an embodiment of the invention; and

FIGS. 4 and 5 are tables of cooking parameters for a new infrared cooking technology, according to an exemplary embodiment of the invention.

The invention may be susceptible to various modifications and alternative forms. Specific exemplary embodiments thereof are shown by way of example in the drawing and are described herein in detail. It should be understood, however, that the description set forth herein of specific embodiments is not intended to limit the present invention to the particular forms disclosed. Rather, all modifications, alternatives, and equivalents falling within the spirit and scope of the invention as defined by the appended claims are intended to be covered.

### DETAILED DESCRIPTION OF SPECIFIC EMBODIMENTS

Referring now to the drawings, the details of exemplary embodiments of the present invention are schematically illustrated. Like elements in the drawings will be represented by like numbers, and similar elements will be represented by like numbers with a different lower case letter suffix.

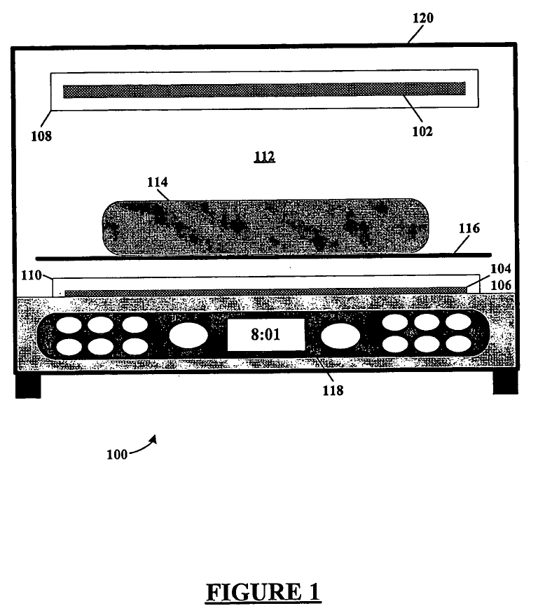

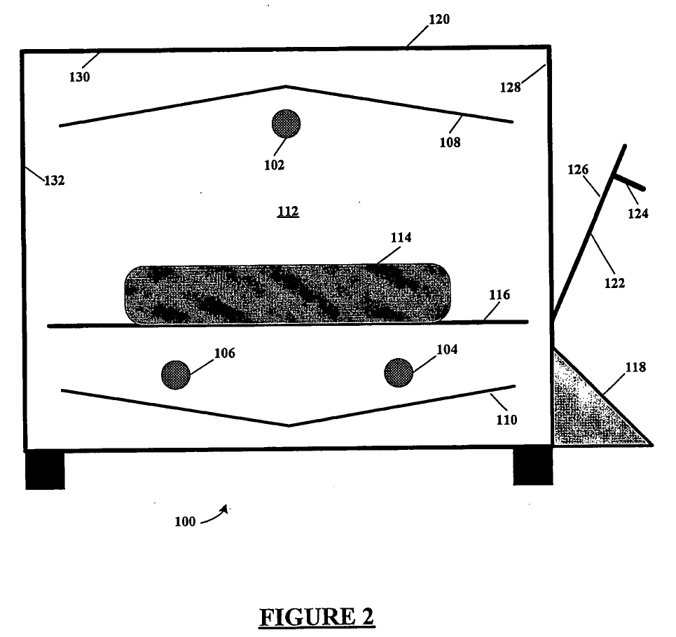

Referring now to FIG. 1, depicted is a schematic elevational front view of a new technology cooking appliance, e.g., infrared oven, more fully described in commonly owned patent application U.S. Ser. No. 10/776,028, filed Feb. 10, 2004, entitled “Multi-Purpose Oven Using Infrared Heating For Reduced Cooking Time” by Luis Cavada and Alvaro Vallejo, and is hereby incorporated by reference herein for all purposes. The infrared oven, generally represented by the numeral 100, comprises a top infrared wavelength emitting radiant heat source (hereinafter top IR heater) 102, bottom infrared wavelength emitting radiant heat sources (hereinafter bottom IR heaters) 104 and 106, top radiant heat reflector 108, bottom radiant heat reflector 110, an oven chamber 112 adapted for cooking a food 114, food tray 116, an intelligent user interface 118, and an oven housing 120. A front door 122 (FIG. 2) is attached to the oven housing 120 and is adapted to be opened and closed, for example, by a handle 124 on the front upper portion of the door 122. The inner surfaces of the oven chamber 112, e.g., front wall 128, top wall 130, rear wall 132, interior surface of the door 122, and/or combinations thereof, may be coated with suitable material, e.g., porcelain, ceramic coatings, to re-radiate IR energy at a desired wavelength(s), e.g., longer or shorter IR wavelength, etc., and/or to achieve a desired operating effect, e.g., a “brick oven.”

The top IR heater 102 is positioned so as to emit infrared radiant heat directly onto the surface of the food located in the oven chamber 112. The top radiant heat reflector 108 is preferably designed to evenly distribute reflected infrared radiant heat energy over the food 114 from the top IR heater 102. The top IR heater 102 may comprise one or more infrared radiant heat sources.

The bottom IR heaters 104 and 106 are located below the food tray 116. The bottom radiant heat reflector 110 directs the infrared radiant heat energy into the food 114 from the bottom IR heaters 104 and 106. The bottom IR heaters 104 and 106 preferably emit lower infrared wavelengths for deeper penetration of food during cooking. The lower infrared wavelengths may pass through the food tray 116 and/or be reflected from the bottom radiant heat reflector 110, and/or walls of the oven enclosure 120. The food tray 116 may be a wire screen, heat resistant glass or ceramic, a metal pan, a grilling plate having vertical ridges thereon (not shown), etc.

The reflectors 108 and 110 are shaped so as to reflect the infrared radiant heat from the top IR heater 102 and the bottom IR heaters 104 and 106, respectively, onto the food in the oven chamber 112. The infrared radiant heat reflected from the reflectors 108 and 110 may be at a longer wavelength than the directly emitted infrared radiant heat from the top IR heater 102 and the bottom IR heaters 104 and 106, respectively. This longer wavelength infrared radiant heat penetrates deeper into the food, thus shortening the moisture evaporation time of the food before surface browning may occur.

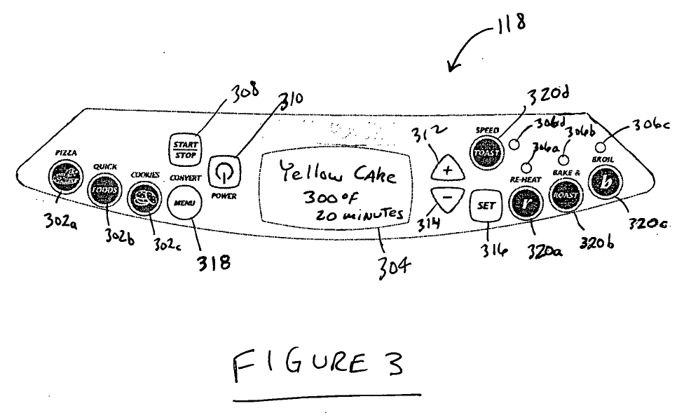

Referring now to FIG. 3, depicted is an intelligent user interface for a new technology cooking appliance, according to an embodiment of the invention. The intelligent user interface, generally represented by the numeral 118, may comprise a plurality of control buttons 302, 308, 310, 312, 314 316, 318 and 320, and a display 304. Control buttons 302 may be used for quick selection of cooking profile parameters for popular foods, e.g., pizza 302a, quick foods 302b, cookies 302c, etc. Oven control function buttons 320 may be implemented, e.g., reheat 320a, bake/roast 320b, broil 320c and speed toast 320d. Optionally, lights 306 may be used to indicate which mode the new technology cooking appliance is operating in, e.g., reheat 306a, bake/roast 306b, broil 306c, or speed toast 306d. The display 304 also may be used to indicate the cooking mode. Cooking temperature and time may be input by pushing the set button 316, pushing the (+) button 312 to increase the parameter value or pushing the (−) button 314 to decrease the parameter value. The set button 316 also may be used to step through various cooking parameters, e.g., temperature and time that may be indicated on the display 304.

A power on-off button 310 may be used to turn the cooking appliance on and off. A start-stop button 308 may be used to start or stop cooking of the food. A menu button 318 may be used to select from a plurality of different foods that may have cooking profiles already defined when using the new technology cooking appliance. The menu button 318 may be pressed and a list of foods, indicated on the display 304, and may be scrolled through with the (+) button 312 and the (−) button 314. In addition, the menu button 318 may be used to select a convert menu for determining a cooking profile of a food not on the menu list. The convert menu can may be used to input cooking parameters of standard old technology cooking and convert these parameters into appropriate new cooking technology parameters so the new cooking technology appliance may cook the desired food to the same expected end result.

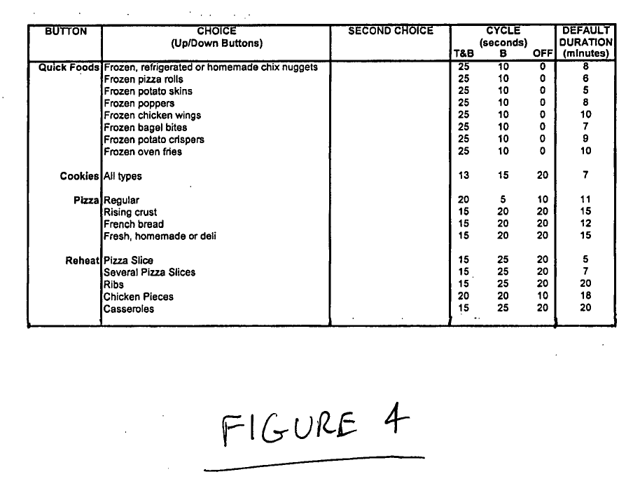

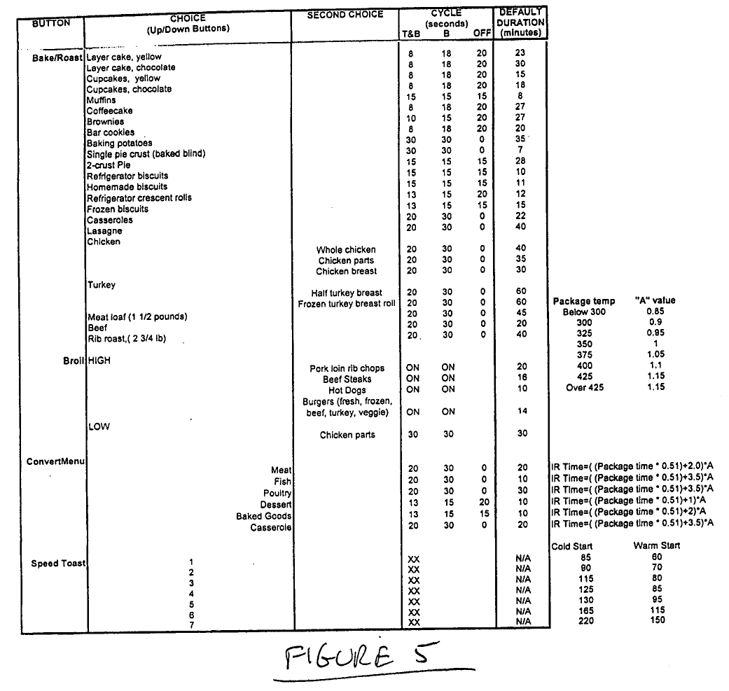

Referring to FIGS. 4 and 5, depicted are tables of cooking parameters for a new infrared cooking technology. The button choices of tables of FIGS. 4 and 5 may be selected through a menu on the display 304, wherein cycle times for the top IR heater 102 and bottom IR heaters 104 and 106 (FIG. 1) and the default duration time in minutes for the heater cycles are programmed as the cooking profile for the selected food to be cooked.

In FIG. 5, the convert menu button may initiate calculation of a cooking profile for the new technology cooking appliance by converting standard cooking package times and temperatures to appropriate times and temperatures using the new technology cooking appliance for proper cooking of the food. For example: the correct meat cooking time may be converted to the new technology cooking time by taking the conventional recommended cooking time, e.g., package time, multiplying by 0.51, adding 2 minutes then adjusting the time by a factor “A” correlated to the conventional recommended cooking temperature. Fish, poultry, deserts, baked goods and casseroles may be converted in a similar fashion as shown in FIG. 5. Speed toasting may be performed for a desired toasting color with time compensation for whether the IR oven is toasting from a cold or warm start.

The invention, therefore, is well adapted to carry out the objects and to attain the ends and advantages mentioned, as well as others inherent therein. While the invention has been depicted, described, and is defined by reference to exemplary embodiments of the invention, such references do not imply a limitation on the invention, and no such limitation is to be inferred. The invention is capable of considerable modification, alteration, and equivalents in form and function, as will occur to those ordinarily skilled in the pertinent arts and having the benefit of this disclosure. The depicted and described embodiments of the invention are exemplary only, and are not exhaustive of the scope of the invention. Consequently, the invention is intended to be limited only by the spirit and scope of the appended claims, giving full cognizance to equivalents in all respects.

1. A new technology cooking appliance having an intelligent user interface, comprising:
a new technology cooking appliance; and
an intelligent user interface for controlling the new technology cooking appliance, wherein the intelligent user interface has a plurality of predefined food cooking profiles selectable by a user.

2. The new technology cooking appliance of claim 1, further comprising a power on-off switch for turning the new technology cooking appliance on and off.

3. The new technology cooking appliance of claim 1, wherein the intelligent user interface comprises:
a display screen for displaying the plurality of predefined food cooking profiles; and
control switches for selecting a desired predefined food cooking profile from the plurality of predefined food cooking profiles.

4. The new technology cooking appliance of claim 3, wherein a start switch starts the new technology cooking appliance, and the new technology cooking appliance is controlled by the selected desired predefined food cooking profile.

5. The new technology cooking appliance of claim 3, wherein a stop switch stops the new technology cooking appliance.

6. The new technology cooking appliance of claim 3, wherein a start-stop switch starts and stops the new technology cooking appliance.

7. The new technology cooking appliance of claim 3, wherein each of the plurality of predefined food cooking profiles are displayed on the display screen by scrolling through a list of the plurality of predefined food cooking profiles.

8. The new technology cooking appliance of claim 7, wherein up and down control switches are used for scrolling through the list of the plurality of predefined food cooking profiles.

9. The new technology cooking appliance of claim 3, wherein cooking modes are selected for the new technology cooking appliance with the control switches.

10. The new technology cooking appliance of claim 9, wherein the selected cooking mode is indicated with a light.

11. The new technology cooking appliance of claim 9, wherein the cooking modes are selected from the group consisting of quick foods, cookies, pizza, reheat, bake-roast, broil, convert-menu and toast.

12. The new technology cooking appliance of claim 11, wherein a quick foods control switch initiates a menu of a plurality of quick foods cooking profiles to be displayed and then selects a one of the plurality of quick foods cooking profiles to control the new technology cooking appliance.

13. The new technology cooking appliance of claim 12, wherein the plurality of quick foods cooking profiles are selected from the group consisting of chicken nuggets, pizza rolls, potato skins, poppers, chicken wings bagel bites, potato crispers and oven fries.

14. The new technology cooking appliance of claim 13, wherein the quick foods are frozen quick foods.

15. The new technology cooking appliance of claim 11, wherein a cookies control switch initiates a cookie cooking profile for controlling the new technology cooking appliance.

16. The new technology cooking appliance of claim 11, wherein a pizza control switch initiates a menu of a plurality of pizza cooking profiles to be displayed and then selects a one of the plurality of pizza cooking profiles to control the new technology cooking appliance.

17. The new technology cooking appliance of claim 16, wherein the plurality of pizza cooking profiles are selected from the group consisting of regular pizza, rising crust pizza, French bread, fresh pizza, homemade pizza and deli pizza.

18. The new technology cooking appliance of claim 11, wherein a reheat control switch initiates a menu of a plurality of reheat cooking profiles to be displayed and then selects a one of the plurality of reheat cooking profiles to control the new technology cooking appliance.

19. The new technology cooking appliance of claim 18, wherein the plurality of reheat cooking profiles are selected from the group consisting of a pizza slice, a plurality of pizza slices, ribs, chicken pieces and a casserole.

20. The new technology cooking appliance of claim 11, wherein a bake-roast control switch initiates a menu of a plurality of bake-roast cooking profiles to be displayed and then selects a one of the plurality of bake-roast cooking profiles to control the new technology cooking appliance.

21. The new technology cooking appliance of claim 20, wherein the plurality of bake-roast cooking profiles are selected from the group consisting of a yellow layer cake, chocolate layer cake, yellow cupcakes, muffins, coffee cake, brownies, bar cookies, baked potatoes, single crust pie, refrigerator biscuits, homemade biscuits, refrigerator crescent rolls, frozen biscuits, casserole, lasagna, chicken, turkey, meat loaf, beef and rib roast.

22. The new technology cooking appliance of claim 21, wherein the chicken bake-roast cooking profile is selected from the group consisting of whole chicken, chicken parts and chicken breast.

23. The new technology cooking appliance of claim 21, wherein the turkey bake-roast cooking profile is selected from the group consisting of half turkey breast and frozen turkey breast roll.

24. The new technology cooking appliance of claim 11, wherein a broil control switch initiates a menu of a plurality of broil cooking profiles to be displayed and then selects a one of the plurality of broil cooking profiles to control the new technology cooking appliance.

25. The new technology cooking appliance of claim 24, wherein the plurality of broil cooking profiles are selected from the group consisting of high broil and low broil.

26. The new technology cooking appliance of claim 25, wherein the high broil cooking profile is selected from the group consisting of pork loin, rib chop, beef steak, hot dog, fresh hamburger, frozen hamburger, beef hamburger, turkey hamburger and vegetable hamburger.

27. The new technology cooking appliance of claim 25, wherein the low broil cooking profile is for chicken parts.

28. The new technology cooking appliance of claim 11, wherein a toast switch initiates a menu of a plurality of toast cooking profiles to be displayed and then selects a one of the plurality of toast cooking profiles to control the new technology cooking appliance.

29. The new technology cooking appliance of claim 11, wherein a convert-menu switch initiates a menu of a plurality of convert-menu cooking profiles to be displayed and then selects a one of the plurality of convert-menu cooking profiles to control the new technology cooking appliance.

30. The new technology cooking appliance of claim 29, wherein the plurality of convert-menu cooking profiles are selected from the group consisting of meat, fish, poultry, dessert, baked goods and casserole.

31. The new technology cooking appliance of claim 29, wherein the selected convert-menu cooking profile converts standard cooking time and temperature to appropriate cooking time for the new technology cooking appliance.

32. The new technology cooking appliance of claim 31, further comprising using weight of a food to be cooked when the selected convert-menu cooking profile converts standard cooking time and temperature to appropriate cooking time for the new technology cooking appliance.

33. The new technology cooking appliance of claim 31, further comprising using thickness of a food to be cooked when the selected convert-menu cooking profile converts standard cooking time and temperature to appropriate cooking time for the new technology cooking appliance.

34. A method for new technology cooking with an intelligent user interface, said method comprising the steps of:
providing a new technology cooking appliance; and
controlling the new technology cooking appliance with an intelligent user interface having a plurality of predefined food cooking profiles selectable by a user.

35. The method of claim 34, further comprising the step of turning the new technology cooking appliance on and off with a power on-off switch.

36. The method of claim 34, wherein the step of controlling the new technology cooking appliance with the intelligent user interface comprises the steps of:
displaying the plurality of predefined food cooking profiles on a display screen; and
selecting a desired predefined food cooking profile from the plurality of predefined food cooking profiles with control switches.

37. The method of claim 36, further comprising the steps of:
starting the new technology cooking appliance with a start switch; and
controlling the new technology cooking appliance with the selected desired predefined food cooking profile.

38. The method of claim 36, further comprising the step of stopping the new technology cooking appliance with a stop switch.

39. The method of claim 36, wherein the steps of starting and stopping the new technology cooking appliance are done with a start-stop switch.

40. The method of claim 36, further comprising the step of displaying a list of the plurality of predefined food cooking profiles on the display screen by scrolling through each of the plurality of predefined food cooking profiles displayed.

41. The method of claim 40, wherein the step of scrolling through each of the plurality of predefined food cooking profiles is done with up and down control switches.

42. The method of claim 36, further comprising the step of selecting cooking modes for the new technology cooking appliance with the control switches.

43. The method of claim 42, further comprising the step of indicating the selected cooking mode with a light.

44. The method of claim 42, wherein the step of selecting cooking modes is from the group consisting of quick foods, cookies, pizza, reheat, bake-roast, broil, convert-menu and toast.

45. The method of claim 44, wherein the step of selecting cooking modes comprises the steps of:
displaying a menu of a plurality of quick foods cooking profiles; and
selecting a one of the plurality of quick foods cooking profiles to control the new technology cooking appliance.

46. The method of claim 45, wherein the step of selecting a one of the plurality of quick foods cooking profiles is from the group consisting of chicken nuggets, pizza rolls, potato skins, poppers, chicken wings bagel bites, potato crispers and oven fries.

47. The method of claim 46, wherein the quick foods are frozen quick foods.

48. The method of claim 44, wherein the step of selecting cooking modes comprises the step of selecting a cookie cooking profile for controlling the new technology cooking appliance.

49. The method of claim 44, wherein the step of selecting cooking modes comprises the steps of:
displaying a menu of a plurality of pizza cooking profiles; and
selecting a one of the plurality of pizza cooking profiles to control the new technology cooking appliance.

50. The method of claim 49, wherein the step of selecting a one of the plurality of pizza cooking profiles is from the group consisting of regular pizza, rising crust pizza, French bread, fresh pizza, homemade pizza and deli pizza.

51. The method of claim 44, wherein the step of selecting cooking modes comprises the steps of:
displaying a menu of a plurality of reheat cooking profiles; and
selecting a one of the plurality of reheat cooking profiles to control the new technology cooking appliance.

52. The method of claim 51, wherein the step of selecting a one of the plurality of reheat cooking profiles is from the group consisting of a pizza slice, a plurality of pizza slices, ribs, chicken pieces and a casserole.

53. The method of claim 44, wherein the step of selecting cooking modes comprises the steps of:
displaying a menu of a plurality of bake-roast cooking profiles; and
selecting a one of the plurality of bake-roast cooking profiles to control the new technology cooking appliance.

54. The method of claim 53, wherein the step of selecting a one of the plurality of bake-roast cooking profiles is from the group consisting of a yellow layer cake, chocolate layer cake, yellow cupcakes, muffins, coffee cake, brownies, bar cookies, baked potatoes, single crust pie, refrigerator biscuits, homemade biscuits, refrigerator crescent rolls, frozen biscuits, casserole, lasagna, chicken, turkey, meat loaf, beef and rib roast.

55. The method of claim 54, wherein the step of selecting the chicken bake-roast cooking profile is from the group consisting of whole chicken, chicken parts and chicken breast.

56. The method of claim 54, wherein he step of selecting the turkey bake-roast cooking profile is from the group consisting of half turkey breast and frozen turkey breast roll.

57. The method of claim 44, wherein the step of selecting cooking modes comprises the steps of:
displaying a menu of a plurality of broil cooking profiles; and
selecting a one of the plurality of broil cooking profiles to control the new technology cooking appliance.

58. The method of claim 57, wherein the step of selecting a one of the plurality of broil cooking profiles is from the group consisting of high broil and low broil.

59. The method of claim 58, wherein the step of selecting the high broil cooking profile is from the group consisting of pork loin, rib chop, beef steak, hot dog, fresh hamburger, frozen hamburger, beef hamburger, turkey hamburger and vegetable hamburger.

60. The method of claim 58, wherein the step of selecting the low broil cooking profile comprises the step of selecting chicken parts.

61. The method of claim 44, wherein a toast switch initiates a menu of a plurality of toast cooking profiles to be displayed and then selects a one of the plurality of toast cooking profiles to control the new technology cooking appliance.

62. The method of claim 44, wherein the step of selecting cooking modes comprises the steps of:
displaying a menu of a plurality of convert-menu cooking profiles; and
selecting a one of the plurality of convert-menu cooking profiles to control the new technology cooking appliance.

63. The method of claim 62, wherein the step of selecting a one of the plurality of convert-menu cooking profiles is from the group consisting of meat, fish, poultry, dessert, baked goods and casserole.

64. The method of claim 62, further comprising the step of converting standard cooking time and temperature to appropriate cooking time for the new technology cooking appliance.

65. The method of claim 64, further comprising the step of determining weight of a food to be cooked before the step of converting standard cooking time and temperature to appropriate cooking time for the new technology cooking appliance.

66. The method of claim 64, further comprising the step of determining thickness of a food to be cooked before the step of converting standard cooking time and temperature to appropriate cooking time for the new technology cooking appliance.
